(19) United States
(12) Patent Application Publication
(10) Pub. No.: US 2009/0186982 A1
(43) Pub. Date: Jul. 23, 2009

(54) ORGANOSILICONE COPOLYMERS

(75) Inventors: Oliver Minge, Munich (DE); Peter Ball, Emmerting (DE); Andrea Kneissl, Ottobrunn (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/302,351

(22) PCT Filed: May 25, 2007
(86) PCT No.: PCT/EP07/55099

§ 371 Date: Nov. 25, 2008

(30) Foreign Application Priority Data
Jun. 1, 2006 (DE) 10 2006 025 668.9

(51) Int. Cl. C08L 43/04; C08F 124/00; C08F 230/08

(52) U.S. Cl. 524/806; 526/273; 526/279

(57) ABSTRACT

Organosilicon polymers prepared by copolymerizing an unsaturated methylol compound, an unsaturated monomer, and an organopolysiloxane bearing at least one unsaturated group exhibit good binding and crosslinking properties when applied to fibers, and the ability to tailor substrate hydrophobicity.

The present invention relates to organosilicone copolymers of ethylenically unsaturated monomers and ethylenically unsaturated polyorganosiloxanes and to their preparation and use.

It is known that the use of polymers in the field of paper and textile finishing is necessary in order that mechanical properties such as tensile strength, breaking extension, elasticity or dry or wet abrasion resistance may be imparted to the substrates and improved. The polymers used include not only natural polymers, in particular starch, but also synthetic polymers which are ideally used in aqueous form because of environmental considerations and statutory regulations. And, following application of the polymer or binder to the fiber, adherence to the substrate shall ideally be good. The aqueous addition polymer dispersions most typically used in this field are therefore those which are functionalized with crosslinking monomers which on drying at high temperature are capable of providing covalent bonds between the addition polymer chains and between the addition polymer and the fiber. This makes it possible to form crosslinked structures which are resistant to the action of extraneous agents.

The functional monomers which are most effective for this use are methylol derivatives of (meth)acrylamide, for example N-methylol (meth)acrylamide (N(M)MA). These monomers are characterized by an ethylenic double bond which allows them to undergo a free-radical polymerization, and by an NHCH₂OH group which ensures crosslinking by means of a condensation reaction with other functional groups at a high temperature of generally above 100° C., frequently under acidic catalysis. This results in the formation of covalent bonds between chains or between an addition polymer chain and the substrate.

For instance, EP 1482081 A1 describes an aqueous copolymer dispersion for the treatment of fibrous nonwoven webs on the basis of vinyl acetate and ethylene which comprise postcrosslinking groups of the N-methylolacrylamide type. The disclosed binders endow the fibers with high dry and wet tensile strength.

EP 143175 B2 discloses N-methylolacrylamide-modified polymeric dispersions based on vinyl ester-acrylate copolymers.

U.S. Pat. No. 6,913,628 discloses another way. Acrylate-based binders are silane modified to achieve postcrosslinkability, which does result in improved tensile strength, but the fiber attachment is not durable, since the Si—O—C bonds formed are hydrolytically labile and pH-sensitive.

All these cited systems have two basic shortcomings in common:

First, even greater dry and wet strength is wanted, or to be more precise a polymer which ensures strengths equivalent to the prior art while being used at a reduced active level.

Secondly, it is known that the known polymers generally have a very unfavorable effect on the haptic properties, for example the softness, of a fabric or fiber (hand).

Other polymers can be applied to improve the haptics of fibers and fabrics. Silicones and silicone-containing structures are generally used to positively influence the softness for example. Again it is desirable for the active to adhere to the substrate. Examples thereof are amino-functional silicone oils (“amine oils”) which, as will be known, positively influence the softness of textiles in particular as well as their hydrophobicity. Owing to their Lewis-basic amino groups they also have the property of “going on to” the Lewis-acidic fibers. Such silicone amine oils and also their uses are described for example in WO2005010076 and are prior art. However, the durability produced by the amine oils going on, however, will be known to be transient and insufficient and the coating is easily removed not only mechanically but also chemically. A further disadvantage of aminosilicones is the fact that there are certain applications where softness is desired but hydrophobicization is not since, for example, the water-imbibing capacity of the fibers is adversely affected.

The present invention provides an organosilicone copolymer (O) obtainable by free-radical polymerization in aqueous medium of

A1) an ethylenically unsaturated monomer selected from N-methylolacrylamide (NMA), N-methylolmethacrylamide, N-methylolallyl carbamate, alkyl ethers or esters of N-methylolacrylamide, of N-methylolmethacrylamide and of N-methylolallyl carbamate, with
A2) an ethylenically unsaturated monomer selected from vinyl esters, (meth)acrylic esters, vinylaromatics, olefins, 1,3-dienes, vinyl ethers and vinyl halides, and
A3) optionally an auxiliary monomer, and
B) a mono- or polyethylenically unsaturated polyorganosiloxane.

The organosilicone copolymers (O) obtained endow treated substrates, such as fibers, paper and textiles, with superior dry and wet tensile strength compared with the prior art and, given an appropriate silicone content, also transfer silicone character to the polymer without adversely affecting the hydrophilicity of the fiber. The hydrophobicization of the substrate is easily fine-tunable.

Preferably, the free-radical polymerization takes place in emulsion or miniemulsion. The resulting aqueous dispersions of the organosilicone copolymers (O) can be used directly for treating the substrates. The aqueous dispersions can also be processed, by drying, to form redispersible polymeric powders. It is particularly preferable for the polymerization to take place in miniemulsion.

Preferred esters (A1) of acrylamidoglycolic acid (AGA) and of methylacrylamidoglycolic acid are the C₁-C₁₀-alkyl esters. Preferred esters (A1) of N-methylolacrylamide, of N-methylolmethacrylamide and of n-methylolallyl carbamate are the esters of C₁-C₁₀-alkylcarboxylic acids. Preferred ethers (A1) of N-methylolacrylamide, of N-methylolmethacrylamide and of N-methylolallyl carbamate are the C₁-C₁₀-alkyl ethers.

Particularly preferred ethylenically unsaturated monomers A1) are N-methylolacrylamide (NMA), N-methylolmethacrylamide and N-methylolallyl carbamate, which each have postcrosslinkable methylol groups.

Preferred ethylenically unsaturated monomers A2) are vinyl esters of carboxylic acids having 1 to 15 carbon atoms. Particular preference is given to vinyl acetate, vinyl propionate, vinyl butyrate, vinyl 2-ethylhexanoate, vinyl laurate, 1-methylvinyl acetate, vinyl pivalate and vinyl esters of α-branched monocarboxylic acids having 9 to 11 carbon atoms, for example VeoVa9R or VeoVa10R (trade names of Resolution). Particular preference is given to vinyl acetate. Preferred monomers A2) from the group of acrylic or methacrylic esters are esters of branched or unbranched alcohols having 1 to 15 carbon atoms. Preferred methacrylic or acrylic esters are methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate and norbornyl acrylate. Particular preference is given to methyl acrylate, methyl methacrylate, n-butyl acrylate, n-butyl methacrylate, isobutyl acrylate, t-butyl acrylate, 2-ethylhexyl acrylate and norbornyl acrylate.

Preferred vinylaromatics A2) are styrene, alpha-methylstyrene, the isomeric vinyltoluenes and vinylxylenes and also divinylbenzenes. Particular preference is given to styrene.

Preferred vinyl halogen compounds are vinyl chloride, vinylidene chloride, tetrafluoroethylene, difluoroethylene, hexylperfluoroethylene, 3,3,3-trifluoropropene, perfluoropropyl vinyl ether, hexafluoropropylene, chlorotrifluoroethylene and vinyl fluoride. Particular preference is given to vinyl chloride.

A preferred vinyl ether A2) is methyl vinyl ether for example. The preferred olefins A2) are ethene, propene, 1-alkylethenes and also polyunsaturated alkenes, and the preferred dienes are 1,3-butadiene and isoprene. Particular preference is given to ethene and 1,3-butadiene.

Particular preference as monomers A2) is given to one or more monomers from the group consisting of vinyl acetate, vinyl esters of α-branched monocarboxylic acids having 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene, 1,3-butadiene.

Particular preference as monomers A2) is also given to mixtures of n-butyl acrylate and 2-ethylhexyl acrylate and/or methyl methacrylate; mixtures of styrene and one or more monomers from the group consisting of methyl acrylate, ethyl acrylate, propyl acrylate, n-butyl acrylate, 2-ethylhexyl acrylate; mixtures of vinyl acetate and one or more monomers from the group consisting of methyl acrylate, ethyl acrylate, propyl acrylate, n-butyl acrylate, 2-ethylhexyl acrylate and optionally ethylene; mixtures of 1,3-butadiene and styrene and/or methyl methacrylate.

Optionally, 0.1% to 5% by weight, based on the total weight of the monomers A1)+A2), of auxiliary monomers A3) can be copolymerized. Preference is given to using 0.5% to 2.5% by weight of auxiliary monomers. Examples of auxiliary monomers A3) are ethylenically unsaturated mono- and dicarboxylic acids, preferably acrylic acid, methacrylic acid, fumaric acid and maleic acid; ethylenically unsaturated carboxylic acid amides and nitriles, preferably acrylamide and acrylonitrile; mono- and diesters of fumaric acid and maleic acid such as the diethyl and diisopropyl esters, and also maleic anhydride, ethylenically unsaturated sulfonic acids and salts thereof, preferably vinylsulfonic acid, 2-acrylamido-2-methylpropanesulfonic acid. Also suitable are epoxide-functional ethylenically unsaturated comonomers such as glycidyl methacrylate and glycidyl acrylate. There may also be mentioned ethylenically unsaturated monomers having hydroxyl or CO groups, for example hydroxyalkyl methacrylates and acrylates such as hydroxyethyl acrylate, hydroxypropyl acrylate, hydroxybutyl acrylate, hydroxyethyl methacrylate, hydroxypropyl methacrylate, hydroxybutyl methacrylate, and also compounds such as diacetone acrylamide and acetylacetoxyethyl acrylate or methacrylate. There may further be mentioned copolymerizable ethylenically unsaturated silanes, for example vinylsilanes such as vinyltrimethoxysilane or vinyltriethoxysilane or (meth)acryloylsilanes, for example the silanes marketed by Wacker-Chemie AG, Munich, Germany under the names of GENIOSIL® GF-31 (methacryloyloxypropyltrimethoxysilane), XL-33 (methacryloyloxymethyltrimethoxysilane), XL-32 (methacryloyloxymethyldimethylmethoxysilane), XL-34 (methyacryloyloxymethylmethyldimethoxysilane) and XL-36 (methacryloyloxymethyltriethoxysilane).

Preferred mono- or polyethylenically unsaturated polyorganosiloxanes B) have the general formula [1]

(SiO_{4/2})ₖ(R¹SiO_{3/2})ₘ(R¹₂SiO_{2/2})ₚ(R¹₃SiO_{1/2})_{q}[O_{1/2}SiR³₂-L-X]_{S}[O_{1/2}H]ₜ [1]

where
L represents a bivalent optionally substituted aromatic, heteroaromatic or aliphatic radical (CR⁴₂)_{b},
R¹, R³, R⁴ represent a hydrogen atom or a monovalent C₁-C₂₀-hydrocarbyl or C₁-C₂₀-hydrocarbyloxy radical which is optionally substituted with —CN, —NCO, —NR²₂, —COOH, —COOR², —PO(OR²)₂, -halogen, -acryloyl, -epoxy, —SH, —OH or —CONR²₂ and in each of which one or more mutually nonadjacent methylene units may be replaced by groups —O—, —CO—, —COO—, —OCO—, or —OCOO—, —S—, or —NR²— and in each of which one or more mutually nonadjacent methine units may be replaced by groups —N═, —N═N—, or —P═,
X represents an ethylenically unsaturated radical,
R² represents hydrogen or a monovalent optionally substituted hydrocarbon radical,
b represents integral values of at least 1,
s represents integral values of at least 1,
t represents 0 or integral values,
k+m+p+q represent integral values of at least 2.

Preferred polyorganosiloxanes B) are those whose C₁-C₂₀-hydrocarbyl and C₁-C₂₀-hydrocarbyloxy radicals R¹, R³, R⁴ may be aliphatically saturated or unsaturated, aromatic, straight-chain or branched. R¹, R³, R⁴ have preferably 1 to 12 atoms, in particular 1 to 6 atoms, preferably just carbon atoms, or one alkoxy oxygen atom and otherwise just carbon atoms.

Preferably R¹, R³, R⁴ are straight-chain or branched C₁-C₆-alkyl radicals or phenyl radicals. Particular preference is given to the radicals methyl, ethyl, phenyl and vinyl.

Preferably R³ is methyl and R⁴ is hydrogen.

X is preferably an ethylenically unsaturated radical of the vinyl type (—C₂H₃), acryloyl type (—OCOC₂H₃) or methacryloyl type (—OCOC₂H₂CH₃).

Preferably b has values of not more than 50, in particular not more than 10. In particularly preferred embodiments b is equal to 2 or 3.

The polyorganosiloxane B) of the general formula [1] may be linear, cyclic, branched or crosslinked. The sum total of k, m, p, q, s and t is preferably a number from 3 to 20 000, in particular 8 to 1000.

A further preferred variant for a polyorganosiloxane B) of the general formula [1] is an organosilicone resin. This resin can consist of two or more units as described in the general formula [1], in which case the mole percentages of the units present are signified by the indices k, m, p, q. k+m must be >0. Preference here is given to using polysiloxane resins B) wherein k+m>50%, based on the sum total of k, m, p, q. Particular preference is given to resins for which k+m>90%.

A further preferred variant for a polyorganosiloxane B) of the general formula [1] is an organosilicone resin consisting exclusively or almost exclusively of SiO_{4/2} units; here the rule is that k is greater than m+p+q. The proportion of k as a percentage of the sum total of k, m, p, q is at least 51%, more preferably >95% or in the range from 55 to 65%.

A further preferred variant for a polyorganosiloxane B) of the general formula [1] is a linear polyorganosiloxane consisting exclusively or almost exclusively of SiO_{2/2} units; here the rule is that the silicone is almost exclusively composed of difunctional units p. The proportion of p as a percentage of the sum total of k, m, p, q is preferably at least 95% and more preferably >95%.

The choice of monomers, or to be more precise choice of the weight fractions for the comonomers A1), A2), optionally A3) and B), is made such that, in general, the resulting glass transition temperature Tg is ≦60° C., preferably in the range from −50° C. to +60° C. The glass transition temperature Tg of the organosilicone copolymers (O) can be determined in a known manner by means of differential scanning calorimetry (DSC). The Tg can also be approximately predicted by means of the Fox equation. According to Fox T. G., Bull. Am. Physics Soc. 1, 3, page 123 (1956), the following equation holds: 1/Tg=x1/Tg1+x2/Tg2+ . . . +xn/Tgn, here xn represents the mass fraction (% by weight/100) of the monomer n and Tgn is the glass transition temperature in kelvin of the homopolymer of the monomer n. Tg values for homopolymers are reported in Polymer Handbook 2nd Edition, J. Wiley & Sons, New York (1975).

The amount of ethylenically unsaturated monomers A1) used is preferably at least 2, in particular at least 8 parts by weight and preferably not more than 100 parts by weight, in particular not more than 30 parts by weight, based on 100 parts by weight of the ethylenically unsaturated monomers A2).

The amount of ethylenically unsaturated polyorganosiloxanes B) used is preferably at least 3, in particular at least 10 parts by weight and preferably not more than 150 parts by weight, in particular not more than 500 parts by weight, based on 100 parts by weight of the ethylenically unsaturated monomers A2).

The organosilicone copolymers (O) are prepared in a heterophase process, preferably by following the known techniques of suspension, emulsion or miniemulsion polymerization (cf. for example Peter A. Lovell, M. S. El-Aasser, “Emulsion Polymerization and Emulsion Polymers” 1997, John Wiley and Sons, Chichester). In a particularly preferred form, the reaction is carried out by following the methodology of miniemulsion polymerization.

Miniemulsion polymerizations differ from other heterophase polymerizations in some essential points which make them particularly suitable for the copolymerization of water-insoluble comonomers or macromers (cf. for example K. Landfester, “Polyreactions in Miniemulsions”, Macromol. Rapid. Commun. 2001, 22, 896-936 and M. S. El-Aasser, E. D. Sudol, “Miniemulsions: Overview of Research and Applications” 2004, JCT Research, 1, 20-31).

The reaction temperatures range from 0° C. to 100° C., preferably from 5° C. to 80° C. and more preferably from 30° C. to 80° C. The pH of the dispersing medium is in the range from 2 to 9 and preferably in the range from 4 to 8. In a particularly preferred embodiment from 6.5 to 7.5. The setting of the pH before the start of the reaction can be done with hydrochloric acid or aqueous sodium hydroxide solution. The polymerization can be carried out batchwise or continuously, with initial charging of all or individual constituents of the reaction mixture, with partial initial charging and subsequent metered addition of individual constituents of the reaction mixture, or by following the metering process without initial charge. All metered additions are preferably at the rate of the consumption of the respective component. A batch-operated polymerization is particularly preferred.

The polymerization in heterogeneous phase preferably proceeds in the presence of one or more dispersants.

Useful dispersants include any of the emulsifiers and/or protective colloids typically used. Suitable protective colloids are for example partially hydrolyzed polyvinyl alcohols, polyvinylpyrrolidones, polyvinyl acetals and also starches and celluloses and their carboxymethyl, methyl, hydroxyethyl and hydroxypropyl derivatives. Suitable emulsifiers include not only anionic and cationic but also nonionic emulsifiers, for example anionic surfactants, such as alkyl sulfates having a chain length of 8 to 18 carbon atoms, alkyl and alkylaryl ether sulfates having 8 to 18 carbon atoms in the hydrophobic moiety and up to 60 ethylene oxide or propylene oxide units, alkyl or alkylaryl sulfonates having 8 to 18 carbon atoms, esters and half-esters of sulfosuccinic acid with monohydric alcohols or alkylphenols, or nonionic surfactants such as alkyl polyglycol ethers or alkylaryl polyglycol ethers having up to 60 ethylene oxide and/or propylene oxide units. Further useful emulsifiers and protective colloids are to be found in “McCutchen's Detergents and Emulsifiers”, North American Edition, 1979. The protective colloids and/or emulsifiers are generally added in the course of the polymerization in an amount of all together 1% to 20% by weight, based on the total weight of the comonomers A1), A2), optionally A3) and B).

The polymerization is initiated by means of the customary, generally at least partially water-soluble initiators or redox initiator combinations. Examples of imitators are the sodium, potassium and ammonium salts of peroxodisulfuric acid, hydrogen peroxide, t-butyl peroxide, t-butyl hydroperoxide, potassium peroxodiphosphate, t-butyl peroxopivalate, cumene hydroperoxide, isopropylbenzene monohydroperoxide and azobisisobutyronitrile. The initiators mentioned are preferably used in amounts of 0.01% to 4.0% by weight, based on the total weight of the comonomers A1), A2), optionally A3) and B). The redox initiator combinations used comprise abovementioned initiators combined with a reducing agent. Suitable reducing agents are sulfites and bisulfites of monovalent cations, for example sodium sulfite, the derivatives of sulfoxylic acid such as zinc or alkali metal formaldehydesulfoxylates, for example sodium hydroxymethanesulfinate and ascorbic acid. The amount of reducing agent is preferably in the range from 0.15% to 3% by weight of the employed comonomers A1), A2), optionally A3) and B). Small amounts of a metal compound which is soluble in the polymerization medium and whose metal component is redox active under the polymerization conditions can be additionally introduced, such a metal compound being based on iron or vanadium for example. Particularly preferred initiators are peroxodisulfate salts, in particular ammonium peroxodisulfates, optionally in combination with reducing agents, in particular sodium hydroxymethanesulfinate.

When the reaction is carried out by following miniemulsion polymerization methodology, predominantly oil-soluble initiators can also be used, examples being cumene hydroperoxide, isopropylbenzene monohydroperoxide, dibenzoyl peroxide or azobisisobutyronitrile. Preferred initiators for miniemulsion polymerizations are potassium persulfate, ammonium persulfate, azobisisobutyronitrile and also dibenzoyl peroxide. An overview of suitable initiators in addition to the representatives just described is to be found in “Handbook of Free Radical Initiators”, E. T. Denisov, T. G. Denisova, T. S. Pokidova, 2003, Wiley Verlag.

To produce water-redispersible polymeric powders, the aqueous dispersions of the organosilicone copolymers (O) are dried in a conventional manner, preferably by following the spray-drying process.

Depending on the planned use, the organosilicone copolymers (O) can be admixed with one or more admixtures where appropriate. Examples of admixtures are solvents or film-forming assistants; mixtures of two or more organic solvents; pigment-wetting and dispersing agents; additives which confer a surface effect, such as for example additives used to achieve textures such as the hammer finish or orange peel texture; antifoams; substrate-wetting agents; surface leveling agents; adhesion promoters; release agents; further organic polymer not identical to the organic polymer of the present invention; surfactant, hydrophobic auxiliary; a non-free-radically polymerizable silicone resin.

The organosilicone copolymers (O) are useful in pure form or as a constituent of aqueous or organic combinations as coatings, binders and overcoatings for a multiplicity of substrates, in particular fabrics and fibers of any kind, for example cellulose fibers, cotton fibers and paper fibers, and also polymeric fibers, including but not limited to polyester, polyamide or polyurethane fibers.

The organosilicone copolymers (O), comprising unsaturated monomers A1) comprising postcrosslinkable methylol groups, are useful for coating shaped articles and surfaces capable of chemically reacting with methylol functions, for example wood or woodbase materials, and also paper-coated substrates and shaped articles.

The treatment of the above substrates with the organosilicone copolymers (O) endow the treated substrate with improved mechanical properties, in particular dry and wet tensile strengths. In addition, given an appropriate silicone content, typical silicone properties are conferred at the same time, including tunable hydrophobicization of the substrate.

All the above symbols of the above formulae each have their meanings independently. The silicon atom is tetravalent in all formulae.

The examples which follow illustrate the invention. Amounts and percentages in the examples which follow are all by weight, unless specifically stated otherwise.

### EXAMPLES

### Example 1

### Preparation of an Inventive Polymeric Dispersion

### Reaction Components:

| | | |
|---|---|---|
| 27 | parts of | methyl methacrylate |
| 27 | parts of | n-butyl acrylate |
| 7.7 | parts of | monomethacryloyl-PDMS (Mₙ about 3200 g/mol) |
| 7.5 | parts of | N-(hydroxymethyl)acrylamide (50% in H₂O) |
| 2 | parts of | itaconic acid |
| 0.15 | part of | ammonium peroxodisulfate |
| 1.5 | parts of | sodium dodecyl sulfate |
| 292 | parts of | water |
| 0.5 | part of | hexadecane |

All the reactants were weighed into a tank and stirred at room temperature for five minutes. Then, the mixture was homogenized at a pressure of about 750 bar with the aid of EmulsiFlex C5 high-pressure homogenizer from Avestin Europe GmbH, Mannheim, Germany. The miniemulsion formed was transferred into a stirred tank and polymerized at 75° C. under nitrogen within 6 hours to give an aqueous polymeric dispersion having a solids content of 19%.

### Example 2

### Preparation of an Inventive Polymeric Dispersion

### Reaction Components:

| | | |
|---|---|---|
| 27 | parts of | methyl methacrylate |
| 27 | parts of | n-butyl acrylate |
| 7.7 | parts of | polymethacryloyl-silicone resin of about 59% |
| | | of SiO_{4/2}, 37% of Me₃SiO_{1/2} & 4% of |
| | | methacryloylmethyldimethylsilyl units |
| 7.5 | parts of | N-(hydroxymethyl)acrylamide (50% in H₂O) |
| 2 | parts of | itaconic acid |
| 0.15 | part of | ammonium peroxodisulfate |
| 1.5 | parts of | sodium dodecyl sulfate |
| 292 | parts of | water |
| 0.5 | part of | hexadecane |

The procedure of Example 1 is repeated.

Solids content: 18%

### Example 3

### Preparation of an Inventive Polymeric Dispersion

### Reaction Components:

| | | |
|---|---|---|
| 27 | parts of | methyl methacrylate |
| 27 | parts of | n-butyl acrylate |
| 7.7 | parts of | monomethacryloyl-PDMS (Mₙ about 6000 g/mol) |
| 7.5 | parts of | N-(hydroxymethyl)acrylamide (50% in H₂O) |
| 4 | parts of | N,N-diethylaminoethyl methacrylate |
| 0.15 | part of | ammonium peroxodisulfate |
| 1.5 | parts of | sodium dodecyl sulfate |
| 292 | parts of | water |
| 0.5 | part of | hexadecane |

The procedure of Example 1 is repeated.

Solids content: 18%

### Example 4

### Preparation of an Inventive Polymeric Dispersion

### Reaction Components:

| | | |
|---|---|---|
| 27 | parts of | methyl methacrylate |
| 27 | parts of | n-butyl acrylate |
| 7.7 | parts of | monomethacryloyl-PDMS (Mₙ about 6000 g/mol) |
| 7.5 | parts of | N-(hydroxymethyl)acrylamide (50% in H₂O) |
| 4 | parts of | N,N-diethylaminoethyl methacrylate |
| 2 | parts of | itaconic acid |
| 0.15 | part of | ammonium peroxodisulfate |
| 1.5 | parts of | sodium dodecyl sulfate |
| 292 | parts of | water |
| 0.5 | part of | hexadecane |

The procedure of Example 1 is repeated.

Solids content: 19%

### Example 5

### Preparation of an Inventive Polymeric Dispersion

### Reaction Components:

| | | |
|---|---|---|
| 27 | parts of | methyl methacrylate |
| 27 | parts of | n-butyl acrylate |
| 23 | parts of | polymethacryloyl-silicone resin of about 59% |
| | | of SiO_{4/2}, 37% of Me₃SiO_{1/2} & 4% of |
| | | methacryloyl-methyldimethylsilyl units |
| 7.5 | parts of | N-(hydroxymethyl)acrylamide (50% in H₂O) |
| 4 | parts of | N,N-diethylaminoethyl methacrylate |
| 0.15 | part of | ammonium peroxodisulfate |
| 1.5 | parts of | sodium dodecyl sulfate |
| 292 | parts of | water |
| 0.5 | part of | hexadecane |

The procedure of Example 1 is repeated.

Solids content: 24%

### Example 6

### Preparation of an Inventive Polymeric Dispersion

### Reaction Components:

| | | |
|---|---|---|
| 27 | parts of | methyl methacrylate |
| 27 | parts of | n-butyl acrylate |
| 7.7 | parts of | α,ω-bis-methacryloyl-PDMS (Mₙ about 1000) |
| 7.5 | parts of | N-(hydroxymethyl)acrylamide (50% in H₂O) |
| 2 | parts of | N,N-diethylaminoethyl methacrylate |
| 2 | parts of | itaconic acid |
| 0.15 | part of | ammonium peroxodisulfate |
| 1.5 | parts of | sodium dodecyl sulfate |
| 292 | parts of | water |
| 0.5 | part of | hexadecane |

The procedure of Example 1 is repeated.

Solids content: 19%

### Example 7

### Preparation of an Inventive Polymeric Dispersion

### Reaction Components:

| | | |
|---|---|---|
| 27 | parts of | methyl methacrylate |
| 27 | parts of | n-butyl acrylate |
| 7.7 | parts of | polymethacryloyl-silicone resin of about 59% |
| | | of SiO_{4/2}, 37% of Me₃SiO_{1/2} & 4% of |
| | | methacryloyl-methyldimethylsilyl units |
| 7.5 | parts of | N-(hydroxymethyl)acrylamide (50% in H₂0) |
| 2 | parts of | N,N-diethylaminoethyl methacrylate |
| 6 | parts of | itaconic acid |
| 0.15 | part of | ammonium peroxodisulfate |
| 1.5 | parts of | sodium dodecyl sulfate |
| 292 | parts of | water |
| 0.5 | part of | hexadecane |

The procedure of Example 1 is repeated.

Solids content: 19%

### Example 8

### Preparation of an Inventive Polymeric Dispersion

### Reaction Components:

| | | |
|---|---|---|
| 27 | parts of | methyl methacrylate |
| 27 | parts of | n-butyl acrylate |
| 7.7 | parts of | polymethacryloyl-silicone resin of about 59% |
| | | of SiO_{4/2}, 37% of Me₃SiO_{1/2} & 4% of |
| | | methacryloyl-methyldimethylsilyl units |
| 7.5 | parts of | N-(hydroxymethyl)acrylamide (50% in H₂O) |
| 2 | parts of | N,N-diethylaminoethyl methacrylate |
| 0.15 | part of | ammonium peroxodisulfate |
| 7 | parts of | polyvinyl alcohol, degree of hydrolysis 88%, |
| | | Höppler viscosity 4 mPas |
| 292 | parts of | water |
| 0.5 | part of | hexadecane |

The procedure of Example 1 is repeated.

Solids content: 18%

### Performance Test

The polymeric dispersions obtained in Examples 1 to 7 were diluted with water to an active content of 5% and sprayed with an airbrush pistol (SATA® 2000 Dekor) onto a nonwoven cloth. After drying at room temperature and storage at 140° C. for 5 minutes, various tests were carried out:

Droplet test: time needed for a droplet to wet the fiber.

Stress-strain measurements: the measurements were carried out on a type 1446 ZWICK® apparatus, at a velocity of 12.7 mm/min, on dry and wet fabric samples measuring 152 mm×25 mm. The quantities measures were: F-max [N], F-max [g-force], stretch F-max [%], work till break, TEA [J].

| | Wettability | Stress-strain measurement, dry cloth | | | | Stress-strain measurement, wet cloth | | | |
|---|---|---|---|---|---|---|---|---|---|
| | Droplet | | | Stretch | Work till | | | Stretch | Work till |
| | test | F-max | F-max | F-max | break/ | F-max | F-max | F-max | break/ |
| Sample | [s] | [N] | [g force] | [%] | TEA [mJ] | [N] | [g force] | [%] | TEA [mJ] |
| Clean cloth | 0.5 | 2.36 | 240.65 | 17.7 | 31 | 0.20 | 20.39 | 13.24 | 2 |
| Water | 0.6 | 2.55 | 260.03 | 18.7 | 34 | 0.23 | 23.45 | 15.01 | 2 |
| Example 1 | 1.3 | 4.30 | 438.48 | 21.46 | 63 | 0.73 | 74.44 | 22.25 | 9 |
| Example 2 | 2.3 | 5.99 | 610.81 | 20.45 | 86 | 1.80 | 183.55 | 21.18 | 22 |
| Example 3 | 1.6 | 4.65 | 474.17 | 20.64 | 63 | 1.47 | 149.90 | 21.21 | 19 |
| Example 4 | 1.3 | 4.24 | 432.36 | 22.19 | 64 | 0.67 | 68.32 | 17.72 | 7 |
| Example 5 | 0.9 | 4.39 | 447.66 | 20.80 | 61 | 0.71 | 72.40 | 17.7 | 8 |
| Example 6 | 1.3 | 5.48 | 558.80 | 21.18 | 77 | 1.04 | 106.05 | 19.95 | 12 |
| Example 7 | 0.9 | 4.62 | 471.11 | 20.35 | 64 | 0.85 | 86.68 | 20.01 | 10 |

Comparative examples (not according to the invention):

| | | | | | | | | | |
|---|---|---|---|---|---|---|---|---|---|
| EKA ® WS 320 | 0.9 | 4.82 | 491.50 | 22.03 | 72 | 0.97 | 98.91 | 21.83 | 11 |
| Cerastar ® C | 0.8 | 4.75 | 484.37 | 20.43 | 67 | 0.22 | 22.43 | 15.99 | 3 |
| Fim | | | | | | | | | |

1.-8. (canceled)

9. An organosilicone copolymer obtained by free-radical polymerization in aqueous medium of
A1) at least one ethylenically unsaturated monomer selected from N-methylolacrylamide (NMA), N-methylolmethacrylamide, N-methylolallyl carbamate, alkyl ethers and esters of N-methylolacrylamide, of N methylolmethacrylamide and of N-methylolallyl carbamate, with
A2) at least one ethylenically unsaturated monomer selected from the group consisting of vinyl esters, (meth)acrylic esters, vinylaromatics, olefins, 1,3-dienes, vinyl ethers and vinyl halides, and
A3) optionally, auxiliary monomer(s), and
B) a mono- or polyethylenically unsaturated polyorganosiloxane.

10. The organosilicone copolymer of claim 9, wherein the ethylenically unsaturated monomer A2) includes at least one vinyl ester of a carboxylic acid having 1 to 15 carbon atoms.

11. The organosilicone copolymer of claim 9, wherein at least one auxiliary monomer A3) is selected from the group consisting of
ethylenically unsaturated mono- and dicarboxylic acids,
ethylenically unsaturated carboxylic acid amides and nitriles,
mono- and diesters of fumaric acid and maleic acid,
ethylenically unsaturated sulfonic acids and salts thereof,
epoxide-functional ethylenically unsaturated comonomers,
ethylenically unsaturated monomers having at least one of hydroxyl groups and CO groups, and ethylenically unsaturated silanes.

12. The organosilicone copolymer of claim 9, wherein the ethylenically unsaturated polyorganosiloxane B) is one of the formula [1]
(SiO_{4/2})ₖ(R¹SiO_{3/2})ₘ(R¹₂SiO_{2/2})ₚ(R¹₃SiO_{1/2})_{q}[0_{1/2}SiR³₂-L-X]ₛ[O_{1/2}H]ₜ [1]
where
L is a bivalent optionally substituted aromatic radical, heteroaromatic radical, or aliphatic radical (CR⁴₂)_{b},
R¹, R³, R⁴ each individually are hydrogen or a monovalent C₁-C₂₀-hydrocarbyl or C₁-C₂₀-hydrocarbyloxy radical which is optionally substituted with —CN, —NCO, —NR²², —COOH, —COOR², —PO(OR²)₂, -halogen, -acryloyl, -epoxy, —SH, —OH or —CONR²₂ and in each of which one or more mutually nonadjacent methylene units may be replaced by groups —O—, —CO—, —COO—, —OCO—, or —OCOO—, —S—, or —NR²— and in each of which one or more mutually nonadjacent methine units may be replaced by groups —N═, —N═N, or —P═,
X is an ethylenically unsaturated radical,
R² is hydrogen or a monovalent optionally substituted hydrocarbon radical,
b is an integer of at least 1,
s is an integer of at least 1,
t is 0 or a positive integer,
k+m+p+q have integral values of at least 2.

13. The organosilicone copolymer of claim 9, wherein free-radical polymerization takes place in emulsion or miniemulsion.

14. A redispersible polymeric powder obtained by drying an aqueous dispersion of an organosilicone copolymer of claim 9.

15. A process for preparing an organosilicone copolymer of claim 9, comprising free radical polymerizing of
A1) at least one ethylenically unsaturated monomer selected from the group consisting of N-methylolacrylamide (NMA), N-methylolmethacrylamide, N-methylolallyl carbamate, alkyl ethers and esters of N-methylolacrylamide, of N methylolmethacrylamide and of N-methylolallyl carbamate, with
A2) at least one ethylenically unsaturated monomer selected from the group consisting of vinyl esters, (meth)acrylic esters, vinyl-aromatics, olefins, 1,3-dienes, vinyl ethers and vinyl halides, and
A3) optionally, one or more auxiliary monomers, and
B) a mono- or polyethylenically unsaturated polyorganosiloxane, the polymerizing taking place in aqueous medium.

16. The organosilicone copolymer of claim 9, which is a component of a coating, binder, or overcoating.
